(19) United States
(12) Patent Application Publication
(10) Pub. No.: US 2026/0018701 A1
(43) Pub. Date: Jan. 15, 2026

(54) RESERVOIR TANK

(71) Applicant: Hanon Systems, Daejeon (KR)

(72) Inventors: Jungbum CHOI, Daejeon (KR); Gwang Ok KO, Daejeon (KR); Seong Woo JEONG, Daejeon (KR)

(73) Assignee: Hanon Systems, Daejeon (KR)

(21) Appl. No.: 18/994,753

(22) PCT Filed: Jul. 11, 2023
(86) PCT No.: PCT/KR2023/009839

§ 371 Date: Jan. 15, 2025

(30) Foreign Application Priority Data
Jul. 18, 2022 (KR) 10-2022-0088128

(51) Int. Cl. H01M 10/6568; B60K 11/02; B65D 88/54; H01M 10/613; H01M 10/625; H01M 10/6551

(52) U.S. Cl. CPC H01M 10/6568; B65D 88/54; H01M 10/613; H01M 10/625; H01M 10/6551; B60K 11/02; H01M 2220/20

(57) ABSTRACT

The present invention relates to a reservoir tank, which has a plurality of spaces partitioned from each other in the reservoir tank and provides each space as a reservoir for each cooling circuit of a cooling system, and thus can solve the problem of insufficient coolant supplementation during pump operation.

### TECHNICAL FIELD

The present invention relates to a reservoir tank applied to a cooling system for a vehicle, and more specifically, to a reservoir tank in which multiple spaces partitioned from each other are formed inside a reservoir tank and each space is provided to each cooling circuit of a cooling system as a reservoir, thereby solving a problem of an insufficient coolant supplementation during operation of a pump.

### BACKGROUND ART

Electric vehicles or hybrid electric vehicles are provided with power electronics (PE) components (e.g., a motor and the like) including a motor, an inverter, an onboard charger (OBC), and the like and also provided with a battery for providing power to the PE components.

Since the components and the battery generate heat during operation, they need to be essentially cooled to protect the components and ensure durability. To this end, electric vehicles or hybrid electric vehicles are provided with a water-cooled PE cooling system for cooling the PE components and a water-cooled battery cooling system for cooling the battery.

Since temperature ranges of main operating areas of the PE components and the battery are different, that is, the PE components are operated at a relatively higher temperature than the battery, the PE components and the battery require separate cooling systems. Accordingly, a PE cooling circuit for circulating and cooling coolant through the PE components, and a battery cooling circuit for circulating and cooling coolant through the battery are each provided. In addition, a radiator circulation line through which coolant is cooled via a radiator may be further provided.

FIG. 1 is a view illustrating a conventional cooling system of an electric vehicle, and as illustrated, separate reservoir tanks R1 and R2 are configured separately for each cooling circuit to operate a separate cooling circuit. In this way, conventional electric vehicles have two reservoir tanks R1 and R2 used for each cooling circuit, and there are problems that it is difficult to install the reservoir tanks in a narrow engine room and a manufacturing cost increases due to an increase in the number of components. In addition, there are problems that a weight increases due to an increase in the number of components, productivity is lowered due to an increase in an installation time of each reservoir tank, and maintenance needs to be performed separately for each cooling circuit.

Furthermore, referring back to FIG. 1, the PE cooling circuit and the battery cooling circuit have pumps P1 and P2, respectively, while a radiator circulation line has no separate pump, and in addition, the two reservoir tanks R1 and R2 are only provided to the PE cooling circuit and the battery cooling circuit, respectively, and no separate reservoir is provided to the radiator circulation line. Accordingly, there may be a problem that a flow of coolant to the radiator circulation line is impeded in a connected operation mode in which the coolant passes through the radiator circulation line, and since the reservoir is not disposed at a front end of a radiator in the corresponding operation mode, lack of momentary coolant supplementation may occur, resulting in problems such as increased noise, deteriorated cooling performance, and the like.

### DISCLOSURE

### Related Art Document

(Patent Document 1) Korean Laid-Open Patent No. 10-2020-0031907 (published on 2020.03.25.)

### Technical Problem

The present invention is directed to providing a reservoir tank which is capable of solving a problem of insufficient coolant supplementation during operation of a pump, preventing deterioration of cooling performance due to bypass of the coolant, improving coolant injectability, and reducing a manufacturing cost.

### Technical Solution

A reservoir tank according to one embodiment of the present invention may include a tank body in which coolant is accommodated in a hollow inner space, and a coolant injection port formed so that the coolant is injected into the inner space of the tank body, the inner space of the tank body may be partitioned into a plurality of spaces, and at least one space is formed not to communicate with other spaces inside the tank body.

The plurality of spaces may include a first space, a second space, and a third space that are partitioned from each other, the first space and the second space communicate with each other, and the third space may be formed as a space separated from and independently of the first space and the second space.

The tank body may be formed as one tank body, and the first space, the second space, and the third space may be partitioned by a partition wall provided in the inner space of the one tank body.

When a partition wall between the first space and the second space is referred to as a first partition wall and a partition wall partitioning the third space is referred to as a second partition wall, the first partition wall may be formed in a structure of a penetrated upper portion so that the first space and the second space communicate with each other through the penetrated upper portion of the first partition wall, and an upper portion of the second partition wall may be closed so that the third space is separated from the first space and the second space.

A maximum height of the third space may be formed to be lower than a preset minimum water level in the first space and the second space.

The coolant inlet may be formed as one coolant inlet, and the one coolant inlet may be disposed on the upper portion of the tank body and a vertical upper portion of the first partition wall.

The tank body may include a first unit tank body and a second unit tank body that are formed by separating the inner space thereof, the first space and the second space may be formed in an inner space of the first unit tank body, and the third space may be formed in an inner space of the second unit tank body.

The partition wall between the first space and the second space may be formed in a structure of a penetrated upper portion so that the first space and the second space communicate with each other through the penetrated upper portion of the corresponding partition wall.

A maximum height of the second unit tank body may be formed to be lower than a preset minimum water level in the first unit tank body.

The coolant inlet may be formed as one coolant inlet, and the one coolant inlet may be disposed on an upper portion of the first unit tank body and a vertical upper portion of the partition wall between the first space and the second space.

Each of the first space to the third space may have a coolant inlet through which coolant is introduced and a coolant outlet through which the coolant is discharged.

The coolant outlet of the first space, the coolant outlet of the second space, and the coolant outlet of the third space may each be directly connected to a valve coupled to one side of the reservoir tank.

Coolant flowing through a power electronics (PE) cooling line may be accommodated in the first space, coolant flowing through a battery cooling line may be accommodated in the second space, and coolant flowing through a radiator circulation line may be accommodated in the third space.

### Advantageous Effects

According to the present invention, by forming a plurality of spaces partitioned from each other inside the reservoir tank and providing each space as the reservoir for each cooling circuit of the cooling system, it is possible to solve the problem of insufficient coolant supplementation during operation of the pump.

In addition, it is possible to prevent deterioration of cooling performance due to bypass of coolant by forming one of a plurality of spaces independently of other spaces.

In addition, it is possible to improve coolant injectability and reduce the manufacturing cost by forming one coolant injection port of the reservoir tank.

### DESCRIPTION OF DRAWINGS

FIG. 1 is a view illustrating a conventional cooling system for an electric vehicle.

FIG. 2 is a top view of the reservoir tank according to one embodiment of the present invention.

FIG. 3 is a side view illustrating the reservoir tank of FIG. 2.

FIG. 4 is a schematic view illustrating a cooling system to which the reservoir tank of the present invention is applied.

FIG. 5 is a top view illustrating a reservoir tank according to another embodiment of the present invention.

FIG. 6 is a top view illustrating the reservoir tank of FIG. 5.

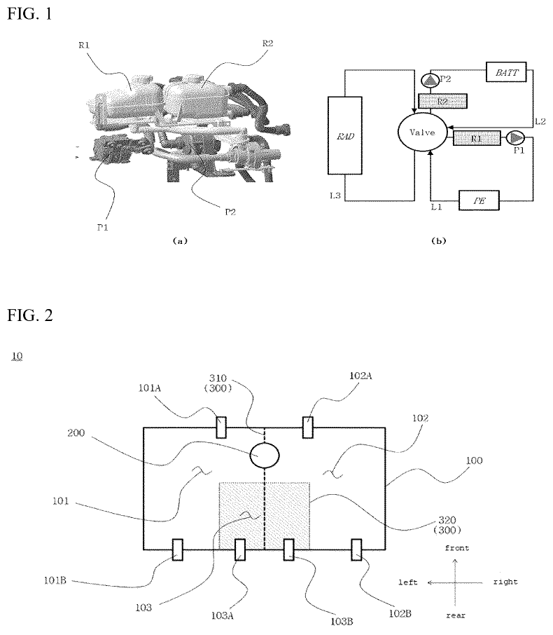

### MODE FOR INVENTION

Hereinafter, the present invention will be described with reference to the accompanying drawings.

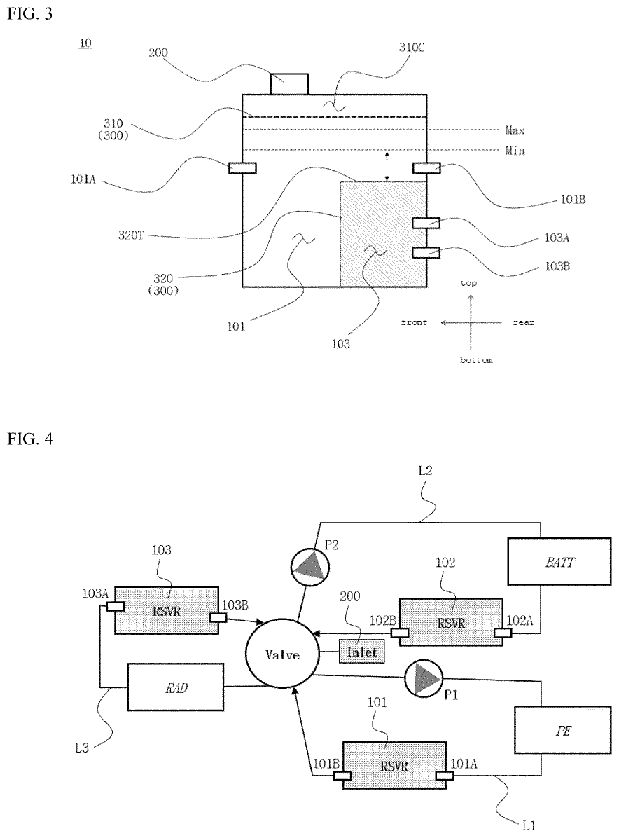

FIG. 2 is a view of the reservoir tank according to one embodiment of the present invention as viewed from the top, and FIG. 3 is a view illustrating the reservoir tank of FIG. 2 as viewed laterally, and as illustrated, a reservoir tank 10 of the present invention includes a tank body 100 and a coolant injection port 200.

The tank body 100 is a component corresponding to an outer housing and has an inner space with a hollow structure so that coolant is accommodated and stored in the inner space.

The coolant injection port 200 is formed to inject coolant into the inner space of the tank body 100 and disposed on an upper portion of the tank body 100. The coolant injection port 200 may be composed of a coolant injection flow path connected to a through-hole that penetrates the upper portion of the tank body 100 and a coolant cap that closes the corresponding coolant injection flow path. The coolant injection port 200 may be formed as one coolant injection port, and more detailed description will be described below.

The reservoir tank 10 of the present invention includes a first space 101, a second space 102, and a third space 103 that are formed by partitioning the inner space of the tank body 100. In order for the inner space of the tank body 100 to include a plurality of spaces partitioned from each other, a partition wall 300 for partitioning the inner space may be provided inside the tank body 100, or the tank body 100 may be composed of a plurality of unit tank bodies, and one or more spaces may be formed in each unit tank body. More detailed description will be described below.

As described above, the reservoir tank 10 of the present invention includes a plurality of spaces, specifically, three spaces, partitioned from each other. An electric vehicle (EV) cooling system may be partitioned into a PE cooling line, a battery cooling line, and a radiator circulation line, and instead of having a reservoir tank for each line, the present invention integrates reservoir tanks of lines into one reservoir tank, and the present invention includes three spaces partitioned from each other so that each space may be individually provided to each line as a reservoir. Specifically, the first space 101 may be disposed on the PE cooling line to accommodate coolant flowing through the PE cooling line, the second space 102 may be disposed on the battery cooling line to accommodate coolant flowing through the battery cooling line, and the third space 103 may be disposed on the radiator circulation line to accommodate coolant flowing through the radiator circulation line.

Referring back to FIGS. 2 and 3, in the reservoir tank 10 of the present invention, a coolant inlet through which coolant flows and a coolant outlet through which the coolant is discharged are provided in each of the first to third spaces 101, 102, and 103. In the drawings, the coolant inlet of the first space 101 is denoted as a first coolant inlet 101A, the coolant outlet of the first space 101 is denoted as a first coolant outlet 101B, the coolant inlet of the second space 102 is denoted as a second coolant inlet 102A, the coolant outlet of the second space 102 is denoted as a second coolant outlet 102B, the coolant inlet of the third space 103 is denoted as a third coolant inlet 103A, and the coolant outlet of the third space 103 is denoted as a third coolant outlet 103B. Each of the coolant inlets and the coolant outlets may be formed in a through-hole structure penetrating the tank body 110, and at least some of them may be formed in a pipe structure extending a predetermined distance therefrom.

In this case, the coolant outlet 101B of the first space, the coolant outlet 102B of the second space, and the coolant outlet 130C of the third space may each be directly connected to a valve Valve coupled to one side of the reservoir tank 10. That is, according to the present invention, the coolant discharged from the reservoir tank may be directly introduced into the valve, circulated through each line of the cooling system via the valve, and then re-introduced into the reservoir tank. Here, the valve may be a multi-directional automation valve for controlling a flow path of the coolant and may correspond to a valve of a coolant control module composed of at least one valve and pump.

FIG. 4 is a schematic view illustrating a cooling system to which the reservoir tank of the present invention is applied. As illustrated, the cooling circuit of the cooling system may be classified as a PE cooling line L1 passing through a PE component PE, a battery cooling line L2 passing through a battery BATT, and a radiator circulation line L3 passing through a radiator RAD. In addition, the PE cooling line L1 and the battery cooling line L2 may each have coolant pumps P1 and P2, respectively, and the radiator circulation line L3 may not have a separate pump.

In the cooling system having such a configuration, the reservoir tank of the present invention may be applied as follows. Coolant in the first space 101 flows directly into the valve through the first coolant outlet 101B, passes through the PE component PE via the first pump P1, and then flows back into the first space 101 through the first coolant outlet 101A. Coolant in the second space 102 flows directly into the valve through the second coolant outlet 102B, passes through the battery BATT via the second pump P2, and then flows back into the second space 102 through the second coolant outlet 102A. Coolant in the third space 103 flows directly into the valve through the third coolant outlet 103B, passes through the radiator RAD, and then flows back into the third space 103 through the third coolant outlet 103A.

In this way, according to the reservoir tank of the present invention, three spaces partitioned from each other are provided to each cooling circuit of the cooling system as reservoirs, and in this case, coolant discharged from each space is formed to flow into the valve so that a reservoir space in which the coolant is stored is formed at a front end of the pump of each cooling circuit in any connection operation mode, thereby solving the problem of insufficient coolant supplementation that may occur momentarily during operation of the pump.

That is, the conventional cooling system is formed in a structure in which coolant discharged from the reservoir tank circulates through each cooling circuit via the pump, then flows into the valve, then may be distributed from the corresponding valve, and re-introduced into the reservoir tank, and in this case, in a specific connection operation mode, for example, in an operation mode in which coolant passes through the radiator, since there is no reservoir at the front end of the pump of the radiator circulation line, the amount of coolant to be supplemented during operation of the pump is insufficient, resulting in problems such as increased noise, deteriorated cooling performance, and the like. However, the present invention is configured so that the reservoir tank is partitioned into three spaces so that the coolant of each space may be supplied to each cooling circuit, and at the same time, configured so that the coolant outlet of each space is directly connected to the valve so that the coolant of each space flows directly into the valve, thereby solving problems such as increased noise, deteriorated performance, and the like in the conventional cooling system.

Meanwhile, re-describing the cooling system of FIG. 4, as described above, the PE cooling line L1 and the battery cooling line L2 each have the coolant pumps P1 and P2, respectively, while the radiator circulation line L3 does not have a separate pump. The radiator circulation line L3 may be configured in a manner that is connected to the PE cooling line L2 through a valve, for example, in a specific connection operation mode so that coolant flows as needed. In this case, the PE cooling line L2 and the radiator circulation line L3 are connected in series, and thus all the coolant passing through the PE component PE needs to be circulated to the radiator RAD.

In this case, when the third space 103 communicates with the first space 101 and the second space 102 so that the third space 103 is connected parallel to the first space 101 and the second space 102, problems that almost no coolant flows to the radiator circulation line L3 without a pump for pressing and transporting coolant and most of the coolant is bypassed to the first space 101 on the PE cooling line L1 with low resistance by the first pump P1 may occur.

That is, the coolant needs to be cooled by passing through the radiator RAD via the radiator circulation line L3, and when the third space 103 communicates with the first space 101 or the second space 102, the coolant in the third space 103 may flow to another space and recirculate through another cooling line to prevent cooling, and thus cooling performance is deteriorated, resulting in a problem of deterioration in the performance of the PE component PE or the battery BATT. To solve such a problem, the third space 103 needs to be formed as an independent space separated from the first space 101 and the second space 102. That is, the reservoir tank 10 of the present invention may include the first to third spaces 101, 102, and 103, and the first space 101 and the second space 102 may communicate with each other, and the third space 103 may be separated from the first space 101 and the second space 102. A specific implementation example implementing such a structure will be described below.

Referring back to FIGS. 2 and 3, FIGS. 2 and 3 are schematic views illustrating a reservoir tank according to one embodiment of the present invention, and the reservoir tank 10 of the present embodiment includes one integrally formed tank body 100 and one coolant inlet 200. In addition, a partition wall 300 is provided in the inner space of the tank body 100, and the first to third spaces 101, 102, and 103 are partitioned from each other by the corresponding partition wall.

Here, when a partition wall between the first space 101 and the second space 102 is referred to as a first partition wall 310 and a partition wall partitioning the third space 103 is referred to as a second partition wall 320, the first partition wall 310 is formed in a structure of a penetrated upper portion so that the first space 101 communicates with the second space 102 through the penetrated upper portion of the first partition wall 310, and an upper portion of the second partition wall 320 is closed so that the third space 103 may be separated from the first space 101 and the second space 102. For example, both the first partition wall 310 and the second partition wall 320 may have a predetermined height upward from the bottom of the tank body 110, and thus upper ends of each of the first partition wall 310 and the second partition wall 320 and an upper surface of the tank body 110 may be spaced a predetermined distance from each other. Among these, the first space 101 may communicate with the second space 102 through a penetrated upper portion 310C of the first partition wall 310, that is, the upper portion of the first partition wall 310 having a predetermined height, and the upper portion of the second partition wall 320 may be closed by a structure such as an upper plate 320T so that the third space 103 may be separated from the first space 101 and the second space 102.

In this case, as illustrated in FIG. 3, the maximum height of the third space 103 may be formed to be lower than a preset minimum water level Min in the first space 101 and the second space 102. To this end, a height of the second partition wall 320 may be formed to be lower than a height of the first partition wall 310. Here, the preset minimum water level Min and the maximum water level Max are the preset preferable amount of coolant to be accommodated and stored inside the reservoir tank 10 and may be marked in the form of lines on an inner or outer surface of the tank body 100.

As described above, the third space 103 performs a reservoir function of the radiator circulation line L3, and the third space 103 has a main function of solving the problem of momentary coolant supply shortage during operation of the pump rather than removing bubbles of coolant. Since the third space 103 is a component independently of the first space 101 and the second space 102, when the third space 103 is formed to be higher than the preset minimum water level Min in the first space 101 and the second space 102, bubbles may be collected inside the third space 103, and the bubbles collected in this way have nowhere to escape. In this case, when the pump is operated momentarily, the bubbles collected in the third space 103 may flow into the cooling circuit, resulting in problems such as noise generation, deteriorated performance, and the like. To solve such a problem, the present invention is configured so that the maximum height of the third space 103 is formed to be lower than the preset minimum water level Min in the first space 101 and the second space 102, thereby fundamentally preventing problems that bubbles are collected inside the third space 103 and the corresponding bubbles flow into the cooling circuit.

In addition, as described above, in the reservoir tank 10 of the present invention, the coolant injection port 200 is formed as one coolant inlet, and the one coolant injection port 200 may be disposed on the upper portion of the tank body 110 and the vertical upper portion of the first partition wall 310. Since the coolant injection port 200 is disposed on the vertical upper portion of the first partition wall 310, the coolant injected through the coolant injection port 200 is distributed to the first space 101 and the second space 102. That is, even when the coolant injection port is formed as one coolant injection port by arranging the coolant injection port on the vertical upper portion of the first partition wall, the coolant may be injected into the first space and the second space at the same time, and since the coolant injection port is formed as one coolant injection port in this way, it is possible to improve coolant injectionability and reduce the manufacturing cost of the reservoir tank.

Here, forming the coolant injection port 200 as one is associated with the first space 101 and the second space 102 communicating with each other, and the first space 101 and the second space 102 may communicate with each other through the penetrated upper portion 310C of the first partition wall, and the coolant injected through the coolant injection port 200 through the penetrated upper portion 310C of the first partition wall may be simultaneously distributed to the first space 101 and the second space 102.

In this case, since the coolant accommodated in the first space 101 and the coolant accommodated in the second space 102 have different temperature ranges, it is preferable that the coolant is not mixed, but the first space 101 and the second space 102 communicate with each other through the upper portions thereof, and thus there is a concern that the coolant may overflow from one side to the other side. However, since an operation duty of the coolant pumps P1 and P2 connected to the first space 101 and the second space 102, respectively, may be adjusted to prevent bypass, the coolant of the two spaces can be prevented from being mixed. In this case, as illustrated in FIG. 3, the minimum height of the penetrated upper portion 310C of the first partition wall, that is, the height of the first partition wall 310, may be formed to be higher than the preset maximum water level Max in the first space 101 and the second space 102, thereby helping to prevent the coolant of the two spaces from being mixed through the penetrated upper portion 310C of the first partition wall.

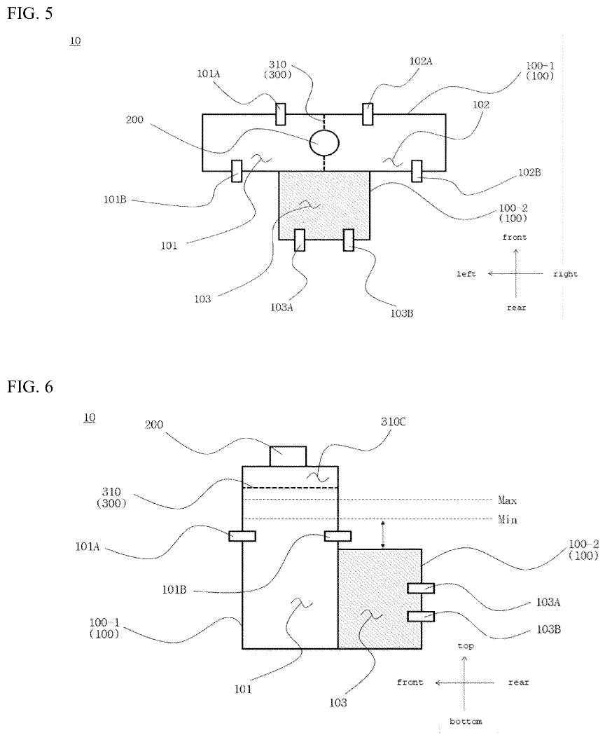

Hereinafter, a reservoir tank according to another embodiment of the present invention will be described. FIG. 5 is a side view of a reservoir tank according to another embodiment of the present invention, and FIG. 6 is a top view of the reservoir tank of FIG. 5, in which the reservoir tank 10 of the present embodiment includes a first unit tank body 100-1 and a second unit tank body 100-2 and includes one coolant injection port 200. In addition, the first space 101 and the second space 102 are formed in an inner space of the first unit tank body 100-1, and the third space 103 is formed in an internal space of the second unit tank body 100-2.

That is, unlike the reservoir tank of the previous embodiment in which the first to third spaces are partitioned by the partition wall in one tank body, there is a difference in that in the reservoir tank of the present embodiment, some of the spaces are partitioned through two unit tank bodies, and specifically, the first and second spaces and the third space are partitioned by different unit tank bodies, and the first and second spaces are partitioned by the partition wall provided inside the first unit tank body. This is advantageous in terms of design and manufacturing in that the structure for partitioning each space and the structure of the partition wall are simple.

In the present embodiment, the first partition wall 310, which is the partition wall 300 between the first space 101 and the second space 102 inside the first tank body 100-1, may have a structure of the penetrated upper portion so that the first space 101 may communicate with the second space 102 through the penetrated upper portion 310C of the partition wall 310. In addition, a maximum height of the second unit tank body 100-2, that is, a maximum height of the third space 103, may be formed to be lower than the preset minimum water level Min in the first unit tank body 100-1, that is, the preset minimum water level Min in the first space 101 and the second space 102. In addition, the coolant injection port 200 may be formed as one coolant injection port, and the corresponding one coolant injection port 200 may be disposed on the upper portion of the first unit tank body 100-1 and the vertical upper portion of the first partition wall 310. In addition, the height of the first partition wall 310 may be formed to be higher than the preset maximum water level Max in the first tank body 100-1. Since the reason or principle for adopting the above configuration is substantially the same as described in the previous embodiment, detailed description thereof is omitted.

As described above, the reservoir tank of the present invention may include three spaces partitioned from each other, and the first space and the second space communicate with each other and the third space is formed as an independent space separated from the first space and the second space, thereby solving the problem of insufficient coolant supplementation during operation of the cooling system, and by forming the maximum height of the third space to be lower than the minimum water levels in the first and second spaces, deterioration of cooling performance due to the bypass of coolant can be prevented, and by forming one coolant injection port, the coolant injection ability into the cooling system can be improved and the manufacturing cost can be reduced.

Although the embodiments of the present invention have been described above with reference to the accompanying drawings, those skilled in the art to which the present invention pertains will understand that the present invention can be carried out in other specific forms without changing the technical spirit or essential features thereof. Accordingly, it should be understood that the above-described embodiments are illustrative and not restrictive in all aspects.

### Description of Reference Numerals

10: reservoir tank
100: tank body
100-1: first unit tank body
100-2: second unit tank body
101: first space
102: second space
103: third space
200: coolant injection port
300: partition wall
310: first partition wall
310C: penetrated upper portion of first partition wall
320: second partition wall

1. A reservoir tank comprising:
a tank body in which coolant is accommodated in a hollow inner space; and
a coolant injection port formed so that the coolant is injected into the inner space of the tank body,
the inner space of the tank body is partitioned into a plurality of spaces, and at least one space is formed not to communicate with other spaces inside the tank body.

2. The reservoir tank of claim 1, wherein the plurality of spaces includes a first space, a second space, and a third space that are partitioned from each other,
the first space and the second space communicate with each other, and
the third space is formed as a space separated from and independently of the first space and the second space.

3. The reservoir tank of claim 2, wherein the tank body is formed as one tank body, and
the first space, the second space, and the third space are partitioned by a partition wall provided in the inner space of the one tank body.

4. The reservoir tank of claim 3, wherein, when a partition wall between the first space and the second space is referred to as a first partition wall and a partition wall partitioning the third space is referred to as a second partition wall,
the first partition wall is formed in a structure of a penetrated upper portion so that the first space and the second space communicate with each other through the penetrated upper portion of the first partition wall, and
an upper portion of the second partition wall is closed so that the third space is separated from the first space and the second space.

5. The reservoir tank of claim 4, wherein a maximum height of the third space is formed to be lower than a preset minimum water level in the first space and the second space.

6. The reservoir tank of claim 4, wherein the coolant injection port is formed as one coolant injection port, and
the one coolant injection port is disposed on the upper portion of the tank body and a vertical upper portion of the first partition wall.

7. The reservoir tank of claim 2, wherein the tank body includes a first unit tank body and a second unit tank body that are formed by separating the inner space thereof,
the first space and the second space are formed in an inner space of the first unit tank body, and
the third space is formed in an inner space of the second unit tank body.

8. The reservoir tank of claim 7, wherein the partition wall between the first space and the second space is formed in a structure of a penetrated upper portion so that the first space and the second space communicate with each other through the penetrated upper portion of the corresponding partition wall.

9. The reservoir tank of claim 8, wherein a maximum height of the second unit tank body is formed to be lower than a preset minimum water level in the first unit tank body.

10. The reservoir tank of claim 8, wherein the coolant injection port is formed as one coolant injection port, and
the one coolant injection port is disposed on an upper portion of the first unit tank body and a vertical upper portion of the partition wall between the first space and the second space.

11. The reservoir tank of claim 2, wherein each of the first space to the third space has a coolant inlet through which coolant is introduced and a coolant outlet through which the coolant is discharged.

12. The reservoir tank of claim 11, wherein the coolant outlet of the first space, the coolant outlet of the second space, and the coolant outlet of the third space are each directly connected to a valve coupled to one side of the reservoir tank.

13. The reservoir tank of claim 2, wherein coolant flowing through a power electronics (PE) cooling line is accommodated in the first space,
coolant flowing through a battery cooling line is accommodated in the second space, and
coolant flowing through a radiator circulation line is accommodated in the third space.
